(19) United States
(12) Patent Application Publication
(10) Pub. No.: US 2026/0316403 A1
(43) Pub. Date: Oct. 15, 2026

(54) COMPOSITES FORMED USING LEWIS-ACID POLYMERIZED POLYOLS AND METHODS OF PREPARING SAME

(71) Applicant: Dow Global Technologies LLC, Midland, MI (US)

(72) Inventors: Masayuki Suzuki, Tokyo (JP); Yun Wang, Beijing (CN); Hongjie Han, Shanghai (CN); Gang Sun, Shanghai (CN); An Nguyen Keaton, Rosharon, TX (US); Enrico Baggio, Correggio (IT); Paolo Diena, Modena (IT); Richard J. Keaton, Rosharon, TX (US)

(21) Appl. No.: 19/491,503

(22) PCT Filed: Jul. 6, 2023
(86) PCT No.: PCT/CN2023/106025

§ 371 Date: Dec. 9, 2025

(51) Int. Cl. B29C 67/24; B29C 67/20; C08K 11/00

(52) U.S. Cl. CPC B29C 67/246; B29C 67/20; C08K 11/00

(57) ABSTRACT

Methods include forming a composite comprising, reacting: an isocyanate component; an isocyanate-reactive component that includes at least one Lewis acid catalyzed polyether polyol having a percent by weight (wt %) of 90 wt % or more polypropylene oxide, a primary hydroxy concentration of at least 30 wt %, a functionality of at least 2, an OH number in the range of 100 mg KOH/g to 800 mg KOH/g, an average acetal content of at least 0.05 wt %, and a water content in the range of 0.1 wt % to 2 wt % based on the weight of the isocyanate-reactive component; and wherein a reinforcing material is present in at least one of the isocyanate component, the isocyanate-reactive component, or a third component.

### FIELD

Embodiments relate to polyurethane compositions used in the fabrication of polyurethane composites and reinforced materials having improved mechanical properties.

### INTRODUCTION

Polyurethane (PU) formulations may be manufactured into reinforced composites for structural parts using a number of methods including long fiber injection (LFI), reinforced, reaction injection molding (RRIM), and the like. For LFI methods, PU resins are sprayed or poured simultaneously with chopped fiber glass into an open mold. As the mold is covered by the LFI-PU material, the mold closes and compression takes place at elevated temperature triggering the cure of the polyurethane. The advantage of the LFI-PU fabrication process is the ability to employ reinforcement fibers of discontinuous in length, which can be concentrated at targeted structural locations. The final composite articles may then exhibit good surface quality and low thermal expansion.

As with most fabrication technologies, the reduction of demolding time with maintained or improved product quality results in increased productivity. To reduce demolding time, higher loadings of catalysts or polyols containing higher concentrations of reactive primary hydroxyl groups (e.g., EO derivatives) can be used. However, the use of polyurethane catalysts can be prohibitively expensive, and can increase volatility and shorten the cure time of the formulation during processing. Polyols containing high concentrations of primary hydroxy groups may be obtained using EO as the alkoxylation reagent, which result in higher hygroscopicity, and can lead to accumulation of water in the formulation when exposed to the atmosphere. The increased polarity of EO-containing polyols can also lead to issues with compatibility with nonpolar formulation components and the generation of haze and turbidity.

### SUMMARY

In an aspect, embodiments of the present disclosure include methods of forming a composite that include reacting an isocyanate component; an isocyanate-reactive component that includes at least one Lewis acid catalyzed polyether polyol having a percent by weight (wt %) of 90 wt % or more polypropylene oxide, a primary hydroxy concentration of at least 30 wt %, a functionality of at least 2, an OH number in the range of 100 mg KOH/g to 800 mg KOH/g, an average acetal content of at least 0.05 wt %, and a water content in the range of 0.1 wt % to 2 wt % based on the weight of the isocyanate-reactive component; and wherein a reinforcing material is present in at least one of the isocyanate component, the isocyanate-reactive component, or a third component.

### BRIEF DESCRIPTION OF THE DRAWINGS

FIG. 1 is a graphical representation of compressive strength as a function of displacement for comparative and Lewis-acid polymerized polyols measured in accordance with ASTM D1621.

### DETAILED DESCRIPTION

Embodiments relate to a two component polyurethane composition for use in composite manufacture in which the composition includes a specific type of Lewis acid catalyzed polyether polyol produced by polymerization in the presence of a perfluoroalkyl-substituted arylborane catalyst. The polyurethane composition includes an isocyanate component and an isocyanate reactive component that includes at least Lewis acid catalyzed polyether polyol. Lewis acid catalyzed polyether polyols disclosed herein may have a percent by weight (wt %) of 90 wt % or more polypropylene oxide, a primary hydroxy concentration of at least 30 wt %, a functionality of at least 2, an OH number in the range of 100 mg KOH/g to 800 mg KOH/g, and an average acetal content of at least 0.05 wt %. Methods also include the formation of a composite that include combining the components in the presence of a reinforcement material using a suitable process such as LFI.

The use of a Lewis acid polymerization catalyst (e.g., perfluoroalkyl-substituted arylborane catalysts) to produce polyether polyols may improve polyol reactivity with the isocyanate component, particularly for polypropylene oxide based (or containing) polyether polyols, by increasing the percentage of primary hydroxyl groups. Increased concentrations of primary hydroxyl groups are associated with faster cure times and improved appearance of the final product. Comparative formulations that include concentrations of polyethylene oxide to increase the percentage of primary OH terminal functional groups, produces some decrease in demold time during manufacture. However, the presence of polyethylene oxide also leads to decreased compatibility with nonpolar polymer phases and layers such as PVC skin layers, production of an open cell structure prone to discoloration by oxidative gases, and high reactivity-related scorching. On the other hand, polypropylene oxide-based polyether polyols show good compatibility with nonpolar phases, but preparation of polyether polyols by standard KOH alkoxylation catalysis from monomers having carbon numbers greater than two (i.e., propylene oxide, butylene oxide) produces products having >95% secondary OH groups.

PU compositions and composites disclosed herein include polyether polyols produced by Lewis acid catalyzed polymerization, which increases the percentage of primary hydroxyl groups and associated performance properties (e.g., reactivity, demolding time, etc). PU compositions and composites disclosed herein exhibit fast demolding and cycle time, while unexpectedly exhibiting enhanced mechanical strength relative to comparatively reactive polyols (e.g., EO-based polyols). In some cases, PU formulations containing Lewis acid catalyzed polyether polyols may enable the formation of composites having good mechanical properties and good adhesion with PVC skin layer. PU compositions disclosed herein may be fast curing with long working time according to ASTM D7487-18 as determined by FOAMAT™ Foam Qualification System (Foamat Messtechnik GmbH, Karlsruhe, DE).

PU compositions disclosed herein generally include the product obtained from combining a two-component curable composition: an isocyanate component (“A-side”) and an isocyanate-reactive component (“B-side”). During application, the isocyanate and isocyanate-reactive components are mixed, initiating a curing reaction, and forming a PU composition or composite. During the formation of a PU composite, the isocyanate component and isocyanate-reactive component may be combined in the presence of a reinforcing material (e.g., carbon fiber, fiber glass). In some cases, the reinforcing material may be combined with at least one of the isocyanate or isocyanate-reactive components prior to PU formation, or may be present as a third component that is combined following the mixture of the isocyanate and isocyanate-reactive components.

Isocyanate components may contain one or more isocyanate compounds, such as polymeric isocyanates, aromatic isocyanates, or carbodiimide-modified isocyanates. Isocyanate compounds may be monomeric, oligomeric, prepolymers, and the like. The isocyanate component can include, for example, one or more isocyanate and/or polyisocyanate compounds. Isocyanate components may include isocyanate compounds having a nominal functionality of 1.5 or greater, or ≥2.0 or greater.

The isocyanate component may include an isocyanate compound having a number average molecular weight of 150 g/mol to 750 g/mol. In some cases, the isocyanate compound can have a number average molecular weight from a low value of 150 g/mol, 200 g/mol, 250 g/mol or 300 g/mol to an upper value of 350 g/mol, 400 g/mol, 450 g/mol, 500 g/mol or 750 g/mol. The number average molecular weight values reported herein are determined by end group analysis, gel permeation chromatography, and other methods as is known in the art. The isocyanate compound can be monomeric and/or polymeric, as are known in the art.

The isocyanate component may include on or more of aliphatic polyisocyanate, cycloaliphatic polyisocyanate, araliphatic polyisocyanate, aromatic polyisocyanate, and the like. Examples of isocyanates include, but are not limited to, polymethylene polyphenylisocyanate; toluene 2,4-/2,6-diisocyanate (TDI); methylenediphenyl diisocyanate (MDI, including its isomers); polymeric and prepolymeric MDI; triisocyanatononane (TIN); naphthyl diisocyanate (NDI); 4,4′-diisocyanatodicyclohexyl-methane; 3-isocyanatomethyl-3,3,5-trimethylcyclohexyl isocyanate (isophorone diisocyanate, IPDI); tetramethylene diisocyanate; hexamethylene diisocyanate (HDI); 2-methyl-pentamethylene diisocyanate; 2,2,4-trimethylhexamethylene diisocyanate (THDI); dodecamethylene diisocyanate; 1,4-diisocyanatocyclohexane; 4,4′-diisocyanato-3,3′-dimethyl-dicyclohexylmethane; 4,4′-diisocyanato-2,2-dicyclohexylpropane; 3-isocyanatomethyl-1-methyl-1-isocyanatocyclohexane (MCI); 1,3-diisooctylcyanato-4-methylcyclohexane; 1,3-diisocyanato-2-methylcyclohexane; and combinations thereof, among others. In addition to the isocyanates mentioned above, partially modified polyisocyanates including uretdione, isocyanurate, carbodiimide, uretonimine, allophanate or biuret structure, and combinations thereof, among others, may be utilized. Examples of commercial isocyanates include, but are not limited to, polyisocyanates under the trade names VORANATE™, VORATRON™, PAPI™, VORAFORCE™ and ISONATE™ available from Dow Chemical Company.

Isocyanate compounds may include isocyanate prepolymers resulting from reaction of an isocyanate-reactive compound with a stoichiometric excess of an isocyanate compound or polymeric isocyanate compound under conditions that do not lead to gelation or solidification, the isocyanate prepolymers can have a higher average isocyanate equivalent weight of >140 g/eq. Formation of isocyanate prepolymers is known in the art, and may include reacting (1) at least one isocyanate compound and (2) at least one polyol compound. Isocyanate prepolymers may be described by the NCO %, defined as the percent by weight on residual isocyanate groups remaining after reaction of the isocyanate-compound with the stoichiometric defect of isocyanate-reactive compound. Isocyanates components disclosed herein may include one or more isocyanate compounds having an NCO content at a percent by weight of above 20 wt %, such as in a range of 20 wt % to 50 wt %, or 20 wt % to 48 wt %.

The isocyanate component includes at least one isocyanate group containing material (such as a polyisocyanate and/or isocyanate-terminated prepolymer). For example, the isocyanate component includes at least one aromatic polyisocyanate, such as methylene diphenyl diisocyanate (MDI) and/or toluene diisocyanate (TDI). To form the polyurethane polymer the isocyanate and isocyanate-reactive components may be mixed and applied to the substrate just before use and/or applied separately to the substrate and allowed to mix on the substrate. The isocyanate component can include at least 50 wt % (at least 60 wt %, at least 70 wt %, at least 80 wt %, at least 90 wt %, at least 95 wt %, at least 98 wt %, etc.) of one or more polyisocyanates, based on a total weight of the isocyanate component.

PU compositions disclosed herein may include an isocyanate component at a percent by weight (wt %) ranging from 15 wt % to 80 wt %, 20 wt % to 80 wt %, or 20 wt % to 70 wt %.

PU compositions may include an isocyanate-reactive component containing at least one polyether polyol prepared using a Lewis acid catalyst. Lewis acid catalyzed polyether polyols may be prepared by polyaddition of alkylene oxides (alkoxylation) onto an initiator (i.e., a polyhydroxy functional starter compound) in the presence of catalysts known in the art that can shape the proportion of primary and secondary hydroxyls in the resulting polymer or oligomer. For example, alkoxylation using a Lewis acid catalyst leads to increased amounts of primary hydroxyls, while the use of basic catalysts that produce secondary hydroxyls as a main product. Representative methods for producing polyether polyols using Lewis acid catalysts are discussed, for example, in WO2019055725 and WO2019055727.

The initiator includes one or more compounds having a low molecular weight and a numerical hydroxyl functionality of at least 2. The initiator is any organic compound that is to be alkoxylated in the polymerization reaction. The initiator may contain as many as 10 hydroxyl groups. For example, the initiator may be a diol or triol. Mixtures of initiators may be used. The initiator will have a hydroxyl equivalent weight less than that of the polyether product, e.g., may have a hydroxyl equivalent weight of less than 500 g/mol equivalence, less than 300 g/mol equivalence, greater than 20 g/mol equivalence, from 20 to 300 g/mol equivalence, from 20 to 200 g/mol equivalence, from 30 to 150 g/mol equivalence, etc. Exemplary, initiator compounds such as ethylene glycol, diethylene glycol, triethylene glycol, propylene glycol, dipropylene glycol, tripropylene glycol, 1,4-butanediol, 1,6-hexanediol, 1,8-octanediol, cyclohexane dimethanol, bisphenol A, glycerin, trimethylolpropane, trimethylolethane, pentaerythritol, sugars and sugar alcohols such as sorbitol and sucrose, and/or alkoxylates of any of these that have a weight average molecular weight less than that of the product of the polymerization.

Lewis acid catalyzed polyether polyols may have a functionality of at least 2 or more such as ranging from 2 to 6, or 2 to 4. Lewis acid catalyzed polyether polyols may have an average primary hydroxyl content of at least 25% or more or 30% or more, such as in the range of 25% to 85%, or 30% to 80%. Lewis acid catalyzed polyols disclosed herein may have low VOC content (e.g., propionaldehyde and acetal), and up to 65% selectivity toward PO-derived primary hydroxyl-terminated polyol chains. Lewis acid catalyzed polyether polyols may have an average acetal content of at least 0.05 wt %, or at least 0.1 wt %.

The Lewis acid catalyst may be an arylborane catalyst that has at least one fluoro/chloro or fluoroalkyl-substituted phenyl group, which may allow for improvements in the yield of the reaction. The polymerization catalyst may be fed into the reactor in an amount greater than 0 and less than or equal to 0.005 (e.g., greater than 0.0001, less than or equal to 0.003, less than or equal to 0.001, etc.) molar equivalents per mole of the initiator feed into the reactor. The Lewis acid catalyst may be active at a lower temperature range (e.g., from 60° C.-110° C.).

The Lewis acid polymerization catalyst has the general formula M(R¹)₁(R²)₁(R³)₁ (R⁴)_{0 or 1}, whereas M is boron, aluminum, indium, bismuth or erbium, R¹ includes (e.g., consists of) a first fluoro/chloro or fluoroalkyl-substituted phenyl group, R² includes (e.g., consists of) a second fluoro/chloro or fluoroalkyl-substituted phenyl group, R³ includes (e.g., consists of) a third fluoro/chloro or fluoroalkyl-substituted phenyl group or a first functional group or functional polymer group, and optional R⁴ is (e.g., consists of) a second functional group or functional polymer group. As used herewithin, by fluoro/chloro or fluoroalkyl-substituted phenyl group it is mean a fluoro/chloro substituted phenyl group or fluoroalkyl-substituted phenyl group, as described below, is present. By fluoroalkyl-substituted phenyl group it is meant a phenyl group that includes a least one hydrogen atom replaced with a fluoroalkyl group. By fluoro-substituted phenyl group it is meant a phenyl group that includes at least one hydrogen atom replaced with a fluorine atom. By chloro-substituted phenyl group it is meant a phenyl group that includes at least one hydrogen atom replaced with a chlorine atom. By fluoro/chloro substituted phenyl group it is meant a phenyl group that includes at least one hydrogen atom replaced with a fluorine or chlorine atom, whereas the phenyl group can include a combination of fluorine and chlorine atom substituents. R¹, R², and R³ may each independently include the fluoro/chloro or fluoroalkyl-substituted phenyl group or may each independently consist essentially of the fluoro/chloro or fluoroalkyl-substituted phenyl group. The M in the general formula may exist as a metal salt ion or as an integrally bonded part of the formula.

With respect to R³ and optional R⁴, the functional group or functional polymer group may be a Lewis base that forms a complex with the Lewis acid catalyst (e.g., a boron based Lewis acid catalyst) and/or a molecule or moiety that contains at least one electron pair that is available to form a dative bond with a Lewis acid (e.g., a cyclic ether such as tetrahydrofunran). The Lewis base may be a polymeric Lewis base. By functional group or functional polymer group it is meant a molecule that contains at least one of the following: water, an alcohol, an alkoxy (examples include a linear or branched ether and a cyclic ether), a ketone, an ester, an organosiloxane, an amine, a phosphine, an oxime, and substituted analogs thereof. Each of the alcohol, linear or branched ether, cyclic ether, ketone, ester, alkoxy, organosiloxane, and oxime may include from 2-20 carbon atoms, from 2-12 carbon atoms, from 2-8 carbon atoms, and/or from 3-6 carbon atoms. For example, the functional group or functional polymer group may have the formula (OYH)ₙ, whereas O is O oxygen, H is hydrogen, Y is H or an alkyl group, and n is an integer (e.g., an integer from 1 to 100). However, other known functional polymer groups combinable with a Lewis acid catalyst such as a boron based Lewis acid catalyst may be used. Exemplary cyclic ethers include tetrahydrofuran and tetrahydropyran.

In some cases, the Lewis acid polymerization catalyst may be that shown in structure I.

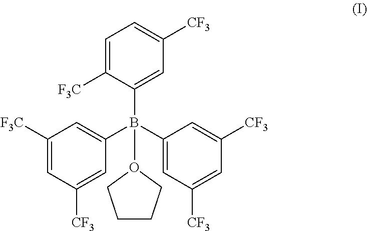

Lewis acid catalyzed polyether polyols may have an OH number in the range 100 mg KOH/g to 900 mg KOH/g, 100 mg KOH/g to 800 mg KOH/g, or 100 mg KOH/g to 750 mg KOH/g. Lewis acid catalyzed polyether polyols may have a number average molecular weight of 400 Da or more, 450 Da or more, or 500 Da or more, such as in a range of 400 Da to 2,000 Da, or 400 Da to 1,500 Da.

Lewis acid catalyzed polyether polyols may have a polypropylene oxide content at a percent by weight (wt %) of 80 wt % or more, or 90 wt % or more. In some cases, the Lewis acid catalyzed polyether polyol may include polypropylene oxide homopolymer (including polypropylene oxide homopolymers polymerized in the presence of a polyhydroxy starter compound).

Lewis acid catalyzed polyether polyols may be present in the isocyanate-reactive component at a percent by weight (wt %) of at least 50 wt % or at least 60 wt %, such as in a range of 40 wt % to 95 wt %, 45 wt % to 95 wt %, or 50 wt % to 90 wt %.

Methods of the present may include long-fiber injection molding process for the preparation of combustion-modified, fiber-reinforced polyurethane composite. Long-fiber injection (LFI) is a well-known technique for fast-curing two-part polyurethanes in the automotive market. The combustion-modified, fiber-reinforced polyurethane composite of the present invention can be prepared by carrying out a long-fiber injection molding process, providing the curable polyurethane resin components, comprising the reactive polyurethane components, polyol and isocyanate, and the isocyanate-reactive brominated compound, with the metal hydrate particulate filler and the fiber, and optionally with the phosphorous-based compound, to a suitable mixing head, discharging the wetted fibers onto the mold. PU compositions disclosed herein may be fast curing with long working time according to ASTM D7487-18 as determined by FOAMAT™ Foam Qualification System (Foamat Messtechnik GmbH, Karlsruhe, DE). PU compositions may have a density according to ASTM D3574-17 Test A of less than 0.850 g/mL, or in a range of 0.3 g/mL to 0.85 g/mL, or 0.3 g/mL to 0.85 g/mL.

Polyurethane foam compositions may include one or more blowing agents, including water and aqueous fluids; chemical blowing agents, such as hydrocarbons, acids, volatile organics, and the like; and physical blowing agents including gases such as nitrogen, air, carbon dioxide, and the like. Blowing agents may be added to the foam-forming composition during mixing at a percent by weight (wt %) ranging from 0.1 wt % to 15 wt %, or 1 wt % to 10 wt %. Blowing agents may be added to the isocyanate component and/or the isocyanate-reactive component in amount sufficient to provide the mixture with the corresponding weight percentages above. In some cases, the blowing agent may be water and added at a percent by weight of the composition ranging from 0.1 wt % to 2 wt % based on the weight of the foam-forming composition.

The isocyanate component and/or the isocyanate-reactive component may have one or more functional additives, as may be useful in the particular manufacturing process that is used or to impart desired characteristics to the resulting foam. These include, for example, catalysts, chain extenders, odor modifiers, fillers, colorants, fire retardants, pigments, antistatic agents, reinforcing fibers, antioxidants, preservatives, acid scavengers, and the like.

Polyurethane compositions and composites structural parts, particularly for larger vehicle, such as buses. The polyurethane system for LFI composite parts includes a two-component polyurethane formulation that are mixed and injected together during LFI to the PVC skin deep-drawn metal mold to manufacture the final article. PU compositions may be used to prepare a molded composite part by a process that includes mixing a PU composition with a reinforcement material or injected into the reinforcement material, e.g., by LFI, reinforced reaction injection molding (RRIM), structural reaction injection molding (SRIM), resin transfer molding (RTM), vacuum assisted resin transfer molding (VARTM) and other reactive processing techniques. Reactive processing techniques can include the production of a composite in a single step, such as polymeric material formation and reinforcement that occur in the same step or cycle. Compositions and methods have been discussed with respect to examples of polyurethane composites produced by LFI, however, it is envisioned that polyurethane composites may be produced by any suitable method without departing from the scope of this disclosure.

Suitable reinforcement materials include any one or more of glass fibers, e-glass fibers, carbon nanotubes, carbon fibers, polyester fibers, natural fibers, glass fibers, aramid fibers, nylon fibers, mineral fibers, basalt fibers, boron fibers, silicon carbide fibers, asbestos fibers, whiskers, hard particles, metal fibers, and the like. Reinforcement materials may include fibers having an aspect ratio (length/diameter) ratio in a range of 600 to 1000. In some cases, the reinforcement material includes fibers (e.g., carbon or glass) having a filament diameter in the range of 15 μm to 25 μm.

Fiber-reinforced polymer composites, and methods and systems for making fiber-reinforced polymer composites. Embodiments of the present invention also include building structures comprising a fiber-reinforced composite of the present invention such as doors, door skins, structural panels for walls and doors (e.g., garage door panels), door frame parts, door and window parts (e.g., cladding for window parts, window frames, and door frames, plant-ons for doors), shingles, shutters, siding, and other building structures comprising fiber-reinforced polymer composites.

While formulation components and properties have been disclosed individually, it is envisioned that component elements (e.g., compounds in isocyanate or isocyanate-reactive components) may be included, excluded, or combined in any manner or subcombination utilizing any of the above concentration ranges and nested subranges therein. Further, that the recited formulation properties may be similarly achieved through various combinations of the recited components within the recited ranges.

All parts and percentages are by weight unless otherwise indicated. All molecular weight values are based on number average molecular weight unless otherwise indicated.

### EXAMPLES

The following examples are provided to illustrate the embodiments of the invention, but are not intended to limit the scope thereof. Table 1 provides the materials used in the following examples.

TABLE 1
Materials used in the examples

| Component | Description | Source |
|---|---|---|
| Isocyanate | Polymeric MDI with NCO content by weight 31.4%, | The Dow Chemical |
| | and with average functionality 2.7 | Company |
| Lewis Acid | Glycerine initiated polyol, all PO, 450 MW triol, about | The Dow Chemical |
| Catalyzed | 60-65% primary OH, OH# 374 mg KOH/g | Company |
| Polyol | | |
| Comparative | Glycerine initiated polyol, all PO, 450 mw triol, >95% | The Dow Chemical |
| Polyol 1 | secondary OH | Company |
| Comparative | Glycerine initiated EO-based polyol, 500 MW triol, | Shanghai Dongda |
| Polyol 2 | 100% primary OH | |
| Polyether | Propylene glycol initiated, 2000 molecular weight, | The Dow Chemical |
| Polyol | homopolymer diol. OH number = 56 mg KOH/g. | Company |
| | Nominal functionality = 2 | |
| Chain | Diethylene glycol (DEG) | SINOPHARM |
| Extender | | |
| Silicone | TEGOSTAB ™ B 8443 | Evonik |
| surfactant 1 | | |
| Silicone | NIAX ™ L580 | Sigma Aldrich |
| surfactant 2 | | |
| Silicone | TEGOSTAB ™ B 8474 | Evonik |
| surfactant 3 | | |
| Catalyst 1 | JEFFCAT ™ ZR-50 | Huntsman |
| | 1-[bis[3-(dimethylamino)propyl]amino]-2-propanol | |
| | amine catalyst | |
| Catalyst 2 | Potassium Acetate, Dabco K2097 | Evonik |
| Catalyst 3 | DABCO ™ 33LV, 33% triethylenediamine dissolved in | Evonik |
| | DPG | |
| TCPP | Tris(2-chloro-1-methylene) phosphate | Arpadis |
| CaCO₃ | calcium carbonate | OMYA |
| Blowing | water | — |
| agent | | |

### Example 1: Properties of Polyurethane Compositions

In this example, samples containing polyurethane compositions were formulated by varying the constituent polyol component, combining with the specified ration of isocyanate, and assaying polyurethane reactivity. Polyurethanes were prepared as 112 g samples. Components were equilibrated to 25° C. and combined using a Heidolph mixer at 3000 rpm. After 10 seconds, cream time (CT) was determined as the PU began to expand. Gel time (GT) was then measured by repeatedly dipping a stick into the foam, and the time that strings form is identified as gel time. Tack Free Time (TFT) is the time that the resulting polymer surface has no stickiness. Free rise density (FRD) for samples was measured after waiting 24 h. The foam will be cut at the center (core) with sizing 5 cm×5 cm×2.5 cm

Inventive sample I1 includes a Lewis acid catalyzed polyol according to the present disclosure, which is a PO-based polyol containing about 60-65% primary OH content. Comparative polyol 1 in C1 is a PO-based polyol having similar properties to the Lewis acid catalyzed polyol, but prepared by standard KOH alkoxylation catalysis leading to >95% secondary OH groups. Comparative polyol 2 in C2 is a EO-based polyol having a similar OH number and functionality as the Lewis acid catalyzed polyol with 100% primary OH content. Sample formulations and results are provided in Table 2.

Table 2: Sample polyurethane compositions for Example 1

TABLE 2
Sample polyurethane compositions for Example 1

| | | | C1 | C2 | I1 |
|---|---|---|---|---|---|
| | Component | OH # | pbw | pbw | pbw |
| Comparative Polyol 1 | | 396 | 65 | — | — |
| Comparative Polyol 2 | | 345 | — | 65 | — |
| Lewis Acid Catalyzed | | 369 | — | — | 65 |
| Polyol | | | | | |
| Polyether Polyol | | 56 | 10 | 10 | 10 |
| Chain Extender | | 1057 | 25 | 25 | 25 |
| Blowing Agent | | 6233.3 | 0.9 | 1.1 | 0.8 |
| Silicone Surfactant 2 | | — | 0.5 | 0.5 | 0.5 |
| L-580 | | | | | |
| Silicone Surfactant 1 | | — | 1 | 1 | 1 |
| B8443 | | | | | |
| Catalyst 1 | | — | 0.2 | 0.2 | 0.2 |
| ZR-50 | | | | | |
| Catalyst 2 | | — | 0.05 | 0.05 | 0.05 |
| Dabco K2097 | | | | | |
| Total formulated polyol | | | 102.67 | 102.85 | 102.55 |
| Weight ratio ISO:POLYOL | | | 72:40 | 72:40 | 72:40 |
| Isocyanate index | | | 1.33 | 1.38 | 1.34 |
| Reagent temp, °C | | | 25 | 25 | 25 |
| Polyurethane | Cream time | s | 120 | 100 | 120 |
| Reactivity | Gel time | s | 230 | 180 | 200 |
| | Rise time | s | 270 | 230 | 240 |
| | Tack free time | s | 600 | 230 | 240 |
| | Density | kg/m³ | 165 | 162 | 168 |

In Table 2, the Isocyanate index corresponds to 100 (a/b), where a=equivalents of isocyanate groups in the 72 parts of isocyanate component and b=equivalents of isocyanate-reactive groups in the 40 parts of formulated polyol component.

Polyurethane reactivity in Table 2 shows that C2 containing the EO-based polyol has the fastest reactivity in terms of rise time and tack free time, while C1 is the slowest. I1 has a reactivity similar to C2.

### Example 2: Compressive Stress Testing of Polyurethane Compositions

In the next example, samples of the polyurethanes prepared substantially similarly as described with respect to Example 1 were tested to quantify the compressive strength and modulus. Compressive stress testing was conducted according to ASTM D1621 at 1 mm/minute. Deformation points for stress calculation at 10%. Foam samples were prepared, aged 24 hours, and dimensioned to 50 mm×50 mm×25 mm with a density of 160 kg/m³.

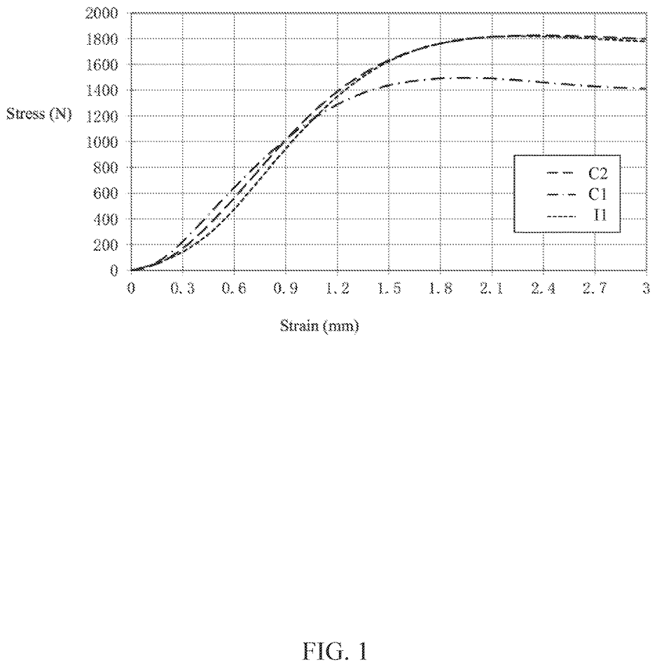

As shown in FIG. 1, I1 formulated with Lewis acid catalyzed polyol exhibits similar compressive strength and modulus as C2 containing polyol 2 (EO-based polyol), while the performance associated with C1 containing polyol 1 (PO-based, primarily secondary OH) is lower.

### Example 3: Polyol Formulation Compatibility and Storage Stability

In this example, isocyanate-reactive (B side) formulations containing sample polyols were prepared and assayed for storage stability. Samples were formulated as shown in Table 2, left to stand and observed every 24 hours for signs of separation. Samples formulated with the Lewis acid catalyzed polyol or with the Comparative Polyol 1 exhibited no separation over the survey period. On the other hand, Comparative Polyol 2 (EO-based polyol) was not compatible and the corresponding formulated polyol showed a phase separation upon storage, with the formation of a layer on top corresponding to about 15% of the total polyol formulation.

### Example 4: Properties of Polyurethane Compositions Containing Filler

Samples were formulated essentially as described in Example 1. Filler was dried at 80° C. for 24 hours before loading into the formulated polyol component.

Reactivity profile of reaction mixtures were prepared as 145 g samples and analyzed using the FOAMAT Foam Qualification system. A horizontal laboratory mold of 200 mm×200 mm×3 mm was used for the preparation of plaques at applied density 600 g/l for thermal and mechanical properties. Flexural properties were measured using specimen at full thickness and using Standard UNI EN ISO 178 with Speed of 10 mm/min.

Thermal analyses to determined glass transition temperature (Tg) were done using UNIVERSAL V TA Q800-DMA instrument. Testing method used: Dual cantilever at 1 Hz, heating rate 3° C./min; specimen dimension 60×12×4 mm; initial temperature 45° C.; final temperature 240° C.

The samples were manufactured using a flat mold dimensioned as (300 mm×300 mm×12 mm with water heating up to 90° C. Although the tested systems are used for composite products produced by the LFI process, the samples produced did not contain glass fiber, to evaluate only the behavior of the PU foam. Acmos 37-7009 was used as external mold release. Reaction components were equilibrated at 25° C. prior to reaction. The liquid weight was 650 g. The reaction temperature after combination was 50° C. The top of the mold was held at 45° C. and the bottom of the mold at 35° C. Sample demolding times were 18 minutes. Estimated Sample Volume was 1.11 L. The average sample weight was 570 g and the average density of the samples was 515 g/L±5 g/L.

Formulation and results are shown in Table 3.

TABLE 3
Formulations and results for Example 4

| Component (g) | C3 | I2 |
|---|---|---|
| B Side | | |
| Water | 0.95 | 0.95 |
| TEGOSTAB B 8474 | 1.38 | 1.38 |
| DABCO ® 33 LV | 1.00 | 1.00 |
| TCPP | 4.60 | 4.60 |
| Filler | 180 | 180 |
| Comparative Polyol 1 | 92.07 | 0 |
| Lewis Acid Catalyzed Polyol | 0 | 92.07 |
| A Side | | |
| Isocyanate index | 115 | 115 |
| Weight ratio ISO/POL | 112.7 | 112.7 |
| Polyurethane Reactivity | | |
| Cream time (s) | 33 | 31 |
| Gel time (s) | 147 | 64 |
| Tack-free time (s) | 217 | 77 |
| Rise time (s) | 200 | 115 |
| Neat polymer properties | | |
| Flexural Max Stress (MPa) | 10.17 | 12.41 |
| Flexural Strain (%) | 1.50 | 1.52 |
| Flexural Modulus (MPa) | 804.8 | 978.2 |
| Tg (°C) | 105.15 | 104.36 |

As shown in Table 3, the reactivity of 12 is much faster, as well as exhibiting surprising improvements in strength and module were obtained with 12 compared to C3.

While the foregoing is directed to exemplary embodiments, other and further embodiments may be devised without departing from the basic scope thereof, and the scope thereof is determined by the claims that follow.

1. A method of forming a composite comprising, reacting:
an isocyanate component;
an isocyanate-reactive component that includes at least one Lewis acid catalyzed polyether polyol having a percent by weight (wt %) of 90 wt % or more polypropylene oxide, a primary hydroxy concentration of 30 wt % to 80 wt %, a functionality of at least 2, an OH number in the range of 100 mg KOH/g to 800 mg KOH/g, an average acetal content of at least 0.05 wt %, and a water content in the range of 0.1 wt % to 2 wt % based on the weight of the isocyanate-reactive component;
wherein the Lewis acid catalyzed polyether polyol is catalyzed by a catalyst having a general formula M(R¹)₁(R²)₁(R³)₁ (R⁴)_{0 or 1}, whereas M is boron, aluminum, indium, bismuth or erbium, R¹, R², R³, and R⁴ are each independent, R¹ includes a first fluoroalkyl-substituted phenyl group, R² includes a second fluoroalkyl-substituted phenyl group, R³ includes a third fluoroalkyl-substituted phenyl group or a first functional group or functional polymer group, and optional R⁴ is a second functional group or functional polymer group; and
wherein a reinforcing material is present in at least one of the isocyanate component, the isocyanate-reactive component, or a third component; and
preparing the composite by long fiber injection.

2. The method of claim 1, wherein the isocyanate-reactive component includes at least 50 wt % of the polyether polyol.

3. The method of claim 1, wherein the polyether polyol is a polypropylene oxide polyol.

4. The method of claim 1, wherein the composite has a density less than 0.85 g/mL.

5. The method of claim 1, wherein the polyether polyol has a weight average molecular weight from 200 Da to 1,000 Da, and a functionality of 2 to 4.

6. (canceled)

7. The method of claim 1, wherein the Lewis acid catalyst forms a dative bond with tetrohydrofuran.

8. The method of claim 1, wherein the isocyanate component is present at a percent by weight (wt %) ranging from 56 wt % to 86 wt %.

9. (canceled)

10. An article prepared by the method of claim 1.
